(19) United States
(12) Patent Application Publication
(10) Pub. No.: US 2022/0060966 A1
(43) Pub. Date: Feb. 24, 2022

(54) Method and Controller for Managing a Microwave Network

(71) Applicant: Telefonaktiebolaget LM Ericsson (publ), Stockholm (SE)

(72) Inventors: Gianmarco Bruno, GENOVA (IT); Marco Marchesini, GENOVA (IT); Carlo Giovanni Perocchio, GENOVA (IT)

(21) Appl. No.: 17/415,160

(22) PCT Filed: Dec. 18, 2018
(86) PCT No.: PCT/EP2018/085477

§ 371 Date: Jun. 17, 2021

(51) Int. Cl. H04W 40/20; H04L 12/24; H04W 40/06; H04W 40/24

(52) U.S. Cl. CPC H04W 40/205; H04L 41/0806; H04W 40/24; H04W 40/06; H04L 41/5003

(57) ABSTRACT

A method (200) for managing a microwave network comprising a plurality of microwave nodes is disclosed, in which a microwave node is associated with a physical microwave path over which the microwave node is operable to transmit or receive a microwave signal, and in which a microwave path of at least some of the microwave nodes in the microwave network is reconfigurable. The method, performed at a domain controller of the microwave network, comprises exposing (210), on an interface of the domain controller, a link topology of the microwave network, wherein the link topology comprises, for a microwave node in the microwave network, a parameter quantifying the extent to which the microwave path associated with the microwave node is reconfigurable.

### TECHNICAL FIELD

The present disclosure relates to a method for managing a microwave network comprising a plurality of microwave nodes. The present disclosure also relates to a controller for managing a microwave network and to a computer program product configured, when run on a computer, to carry out a method for managing a microwave network.

### BACKGROUND

The production, build and expansion of microwave links is a key part of the telecom industry. Current microwave nodes realise wireless point-to-point connections employing passive or active repeaters and providing connectivity up to 10 Gbit/s over up to tens of km. The IETF draft “A framework for Management and Control of microwave and millimeter wave interface parameters” draft-ietf-ccamp-microwave-framework-06 (Reference 1) indicates that the main application for microwave networks is providing backhaul for mobile broadband. Backhaul networks will continue to be modernised in the coming years using a combination of microwave and fiber technologies.

Current microwave networks are composed of links having a fixed geographical orientation. A link therefore connects the same two nodes for all of its working life. Fault tolerance for such links is achieved through redundant hardware, with associated costs for installation, power and maintenance. The fixed nature of microwave links imposes significant advance planning and resourcing to accommodate future connectivity requirements. A microwave link may for example be over resourced in an initial deployment to accommodate an expected evolution in traffic patterns. Even with such forward planning and resourcing, changes in network traffic may require adjustment of microwave links, requiring manual intervention at the individual microwave nodes. Manual intervention imposes time delays and increased costs for the microwave network to evolve with the connectivity requirements of the network traffic it is required to service.

### SUMMARY

It is an aim of the present invention to provide a method, apparatus and computer readable medium which at least partially address one or more of the challenges discussed above.

According to a first aspect of the present disclosure, there is provided a method for managing a microwave network comprising a plurality of microwave nodes, wherein a microwave node is associated with a physical microwave path over which the microwave node is operable to transmit or receive a microwave signal. A microwave path of at least some of the microwave nodes in the microwave network is reconfigurable. The method, performed at a domain controller of the microwave network, comprises exposing, on an interface of the domain controller, a link topology of the microwave network, wherein the link topology comprises, for a microwave node in the microwave network, a parameter quantifying the extent to which the microwave path associated with the microwave node is reconfigurable.

For the purposes of the present specification, a microwave path of a microwave node is reconfigurable if its geographical orientation may be adjusted by the microwave node during the operational life of the node, that is after the initial deployment phase during which the path of the node may be established according to a desired topology of the microwave network. A geographical orientation of a microwave path refers to the direction in which the path travels, represented for example by azimuth and elevation angles at an end point of the path, or by coordinates of the path's end points. Reconfiguration of a microwave path is thus distinguished from reconfiguration of a signal transmitted or received over the path, including for example a change in the bit-rate, the modulation format or the digital framing of a signal transmitted or received over the path. A path may be reconfigurable owing to actuators installed at an antenna of the node and operable to change the orientation of the antenna, and/or owing to beamforming techniques applied at the node.

According to examples of the present disclosure, a microwave node may be associated with a single path, which may be serviced by a single antenna or by a group of antennas operated together, for example operable to provide Multiple In Multiple Out (MIMO) functionality. Multiple nodes may therefore be co-located at the same geographical site, with different nodes associated with microwave paths connecting the site to a range of other sites in different locations, each path serviced by one or more antennas.

According to examples of the present disclosure, the domain controller which may perform the method may comprise an SDN controller such as a Provisioning Network Controller in an ACTN hierarchy.

According to examples of the present disclosure, the interface may comprise a northbound interface.

According to examples of the present disclosure, the parameter quantifying the extent to which the microwave path associated with a microwave node is reconfigurable may comprise at least one of a maximum azimuth for the path of the node, a minimum azimuth for the path of the node, a maximum elevation for the path of the node and/or a minimum elevation for the path of the node.

According to examples of the present disclosure, the link topology of the microwave network may further comprise, for a microwave node in the microwave network, a parameter quantifying the current microwave path of the microwave node.

According to examples of the present disclosure, the parameter quantifying the current microwave path of a microwave node may comprise at least one of current configured azimuth for the path of the node, current actual azimuth for the path of the node, current configured elevation for the path of the node and/or current actual elevation for the path of the node.

According to examples of the present disclosure, current configured azimuth and elevation may comprise values of azimuth and elevation that the microwave node is configured to apply, and current actual azimuth and elevation may comprise values of azimuth and elevation that are currently captured by the network for the microwave node.

According to examples of the present disclosure, current actual values may be captured by the network through measurement readings and/or reporting, and a difference between current configured and current actual values may arise owing to self-optimisation at the node or to error.

According to examples of the present disclosure, the link topology of the microwave network may further comprise, for a microwave node in the microwave network, a microwave link budget parameter.

According to examples of the present disclosure, the microwave link budget parameter may comprise at least one of a terrain factor and/or a climate factor.

According to examples of the present disclosure, the link topology of the microwave network may further comprise, for a microwave node in the microwave network, geographic coordinates for the microwave node.

According to examples of the present disclosure, the method may further comprise, for a microwave node in the microwave network, receiving from the microwave node the parameter quantifying the extent to which the microwave path associated with the microwave node is reconfigurable.

According to examples of the present disclosure, the method may further comprise, for a microwave link in the link topology of the microwave network, storing, as a backup microwave link in a data store, current configured values of azimuth and elevation for the microwave paths associated with the microwave nodes forming endpoints of the link.

According to examples of the present disclosure, the method may further comprise, for the backup microwave link, storing, in the data store, current actual values of azimuth and elevation for the microwave paths associated with the microwave nodes forming endpoints of the link.

According to examples of the present disclosure, the method may further comprise indexing, in the data store, the stored values of azimuth and elevation for the backup microwave link with an identifier comprising identifiers of the microwave nodes forming endpoints of the link.

According to examples of the present disclosure, the method may further comprise storing in the data store at least one of a date or a time at which the backup microwave link has been used in the microwave network.

According to examples of the present disclosure, the method may further comprise using the parameter quantifying, for a microwave node in the microwave network, the extent to which the microwave path associated with the microwave node is reconfigurable, to evaluate the feasibility of a potential new path between microwave nodes in the microwave network.

According to examples of the present disclosure, the method may further comprise using the parameter to evaluate the feasibility of a potential new path between microwave nodes in the microwave network in the event of a change in the link topology of the microwave network.

According to examples of the present disclosure, using the parameter quantifying, for a microwave node in the microwave network, the extent to which the microwave path associated with the microwave node is reconfigurable, to evaluate the feasibility of a potential new path between microwave nodes in the microwave network may comprises identifying a change in the link topology of the microwave network. Using the parameter may further comprise identifying a path between first and second microwave nodes in the microwave network, which path is impacted by the change in topology, the path comprising at least one microwave link, identifying a potential new path between the first and second microwave nodes, which path maintains connectivity between the first and second nodes in the changed link topology, and evaluating the feasibility of the potential new path on the basis of parameters quantifying the extent to which the microwave paths associated with the first and second microwave nodes are reconfigurable.

According to examples of the present disclosure, the method may further comprise, if the potential new path between the first and second microwave nodes is evaluated as feasible, instructing the first and second microwave nodes to reconfigure their associated microwave paths to form the potential new path.

According to examples of the present disclosure, instructing the first and second microwave nodes to reconfigure their associated microwave paths to form the potential new path may comprise configuring the first and second microwave nodes with azimuth and elevation values corresponding to microwave paths that will form the potential new path.

According to examples of the present disclosure, the method may further comprise checking the data store for backup microwave links having the first or second microwave nodes as endpoints, determining whether the potential new path can be formed from stored backup links, and, if the potential new path can be formed from stored backup links, identifying the stored backup links required to form the potential new path and instructing the first and second microwave nodes to reconfigure their associated microwave paths to match the microwave paths of the identified backup links.

According to examples of the present disclosure, the method may further comprise checking, for example, weather or traffic conditions at a date and/or time associated with the backup links in order to determine whether the backup links are appropriate for use in the current weather and/or traffic conditions.

According to examples of the present disclosure, the method may further comprise, if the potential new path cannot be formed from stored backup links, proceeding to evaluate the feasibility of the potential new path on the basis of parameters quantifying the extent to which the microwave paths associated with the first and second microwave nodes are reconfigurable.

According to examples of the present disclosure, identifying a change in the link topology of the microwave network may comprise identifying a microwave node in the microwave network that has become at least partially unavailable. According to examples of the present disclosure, identifying a path between first and second microwave nodes in the microwave network, which path is impacted by the change in topology, the path comprising at least one microwave link, may comprise identifying a path comprising a microwave link that terminates at the at least partially unavailable node. According to examples of the present disclosure, identifying a potential new path between the first and second microwave nodes, which path maintains connectivity between the first and second nodes in the changed link topology, may comprise identifying a path comprising a single microwave link between the first and second microwave nodes.

According to examples of the present disclosure, identifying a microwave node in the microwave network that has become at least partially unavailable may comprise identifying a microwave node in the microwave network that has become at least partially unavailable owing to at least one of a failure affecting the microwave node and/or a programmed downtime for the microwave node.

According to examples of the present disclosure, programmed downtime may include scheduled repairs or maintenance work, or scheduled downtime during periods of low traffic load, for example scheduled overnight downtime for energy saving.

According to examples of the present disclosure, identifying a change in the link topology of the microwave network may comprise identifying a microwave node in the microwave network that has become newly available. According to examples of the present disclosure, identifying a path between first and second microwave nodes in the microwave network, which path is impacted by the change in topology, the path comprising at least one microwave link, may comprise identifying a path the capacity of which may be increased by passing via the newly available node. According to examples of the present disclosure, identifying a potential new path between the first and second microwave nodes, which path maintains connectivity between the first and second nodes in the changed link topology, may comprise identifying a path comprising a microwave link that terminates at the newly available node.

According to examples of the present disclosure, identifying a microwave node in the microwave network that has become newly available may comprise identifying a microwave node in the microwave network that has become newly available owing to at least one of a new microwave node installation and/or a node becoming available after a failure or programmed downtime.

According to examples of the present disclosure, the method may further comprise determining a difference in capacity between the identified path and the potential new path, and engineering traffic on the potential new path to accommodate the difference in capacity. For example, if the potential new path has reduced capacity compared to the identified path, engineering traffic on the potential new path to accommodate the difference in capacity may comprise filtering traffic on the path according to a priority level of the traffic, so as to ensure that low priority traffic is dropped or diverted and high priority traffic is delivered over the potential new path.

According to another aspect of the present disclosure, there is provided a method for operating a microwave node in a microwave network, the microwave node being associated with a physical microwave path over which the microwave node is operable to transmit or receive a microwave signal. The method, performed at the microwave node, comprises reporting, to a domain controller of the microwave network, a parameter quantifying the extent to which the microwave path associated with the microwave node is reconfigurable.

According to examples of the present disclosure, the parameter quantifying the extent to which the microwave path associated with a microwave node is reconfigurable may comprise at least one of a maximum azimuth for the path of the node, a minimum azimuth for the path of the node, a maximum elevation for the path of the node and/or a minimum elevation for the path of the node.

According to examples of the present disclosure, the method may further comprise reporting, to the domain controller of the microwave network, a parameter quantifying the current microwave path of the microwave node.

According to examples of the present disclosure, the parameter quantifying the current microwave path of a microwave node may comprise at least one of current configured azimuth for the path of the node, current actual azimuth for the path of the node, current configured elevation for the path of the node and/or current actual elevation for the path of the node.

According to examples of the present disclosure, current configured azimuth and elevation may comprise values of azimuth and elevation that the microwave node is configured to apply and current actual azimuth and elevation may comprise values of azimuth and elevation that are currently captured by the network for the microwave node.

According to another aspect of the present disclosure, there is provided a computer program comprising instructions which, when executed on at least one processor, cause the at least one processor to carry out a method according to any one of the preceding aspects or examples of the present disclosure.

According to another aspect of the present disclosure, there is provided a carrier containing a computer program according to the preceding aspect of the present disclosure, wherein the carrier comprises one of an electronic signal, optical signal, radio signal or computer readable storage medium.

According to another aspect of the present disclosure, there is provided a computer program product comprising non transitory computer readable media having stored thereon a computer program according to a preceding aspect of the present disclosure.

According to another aspect of the present disclosure, there is provided a domain controller for managing a microwave network comprising a plurality of microwave nodes, wherein a microwave node is associated with a physical microwave path over which the microwave node is operable to transmit or receive a microwave signal, and wherein a microwave path of at least some of the microwave nodes in the microwave network is reconfigurable. The domain controller comprises a processor and a memory, the memory containing instructions executable by the processor such that the domain controller is operable to expose, on an interface of the domain controller, a link topology of the microwave network, wherein the link topology comprises, for a microwave node in the microwave network, a parameter quantifying the extent to which the microwave path associated with the microwave node is reconfigurable.

According to examples of the present disclosure, the domain controller may be further operable to carry out a method according to any one of the preceding aspects or examples of the present disclosure.

According to another aspect of the present disclosure, there is provided a domain controller for managing a microwave network comprising a plurality of microwave nodes, wherein a microwave node is associated with a physical microwave path over which the microwave node is operable to transmit or receive a microwave signal, and wherein a microwave path of at least some of the microwave nodes in the microwave network is reconfigurable. The domain controller is adapted to expose, on an interface of the domain controller, a link topology of the microwave network, wherein the link topology comprises, for a microwave node in the microwave network, a parameter quantifying the extent to which the microwave path associated with the microwave node is reconfigurable.

According to examples of the present disclosure, the domain controller may be further adapted to carry out a method according to any one of the preceding aspects or examples of the present disclosure.

According to another aspect of the present disclosure, there is provided a microwave node in a microwave network, the microwave node being associated with a physical microwave path over which the microwave node is operable to transmit or receive a microwave signal. The microwave node comprises a processor and a memory, the memory containing instructions executable by the processor such that the microwave node is operable to report, to a domain controller of the microwave network, a parameter quantifying the extent to which the microwave path associated with the microwave node is reconfigurable.

According to examples of the present disclosure, the microwave node may be further operable to carry out a method according to any one of the preceding aspects or examples of the present disclosure.

According to another aspect of the present disclosure, there is provided a microwave node in a microwave network, the microwave node being associated with a physical microwave path over which the microwave node is operable to transmit or receive a microwave signal. The microwave node is adapted to report, to a domain controller of the microwave network, a parameter quantifying the extent to which the microwave path associated with the microwave node is reconfigurable.

According to examples of the present disclosure, the microwave node may be further adapted to carry out a method according to any one of the preceding aspects or examples of the present disclosure.

### BRIEF DESCRIPTION OF THE DRAWINGS

For a better understanding of the present invention, and to show more clearly how it may be carried into effect, reference will now be made, by way of example, to the following drawings in which:

FIG. 1 illustrates an ACTN hierarchy for a transport network;

FIG. 2 is a flow chart illustrating process steps in a method for managing a microwave network;

FIGS. 3a to 3c show a flow chart illustrating process steps in another example of a method a method for managing a microwave network;

FIG. 4 is a flow chart illustrating process steps in a method for operating a microwave node in a microwave network;

FIG. 5 is a schematic illustration of an example microwave network;

FIGS. 6 to 8 illustrate example use cases for methods for managing a microwave network;

FIG. 9 is a schematic illustration of another example microwave network;

FIG. 10 is a block diagram illustrating functional units in a domain controller;

FIG. 11 is a block diagram illustrating functional units in another example of domain controller;

FIG. 12 is a block diagram illustrating functional units in a microwave node;

FIG. 13 is a block diagram illustrating functional units in another example of microwave node.

### DETAILED DESCRIPTION

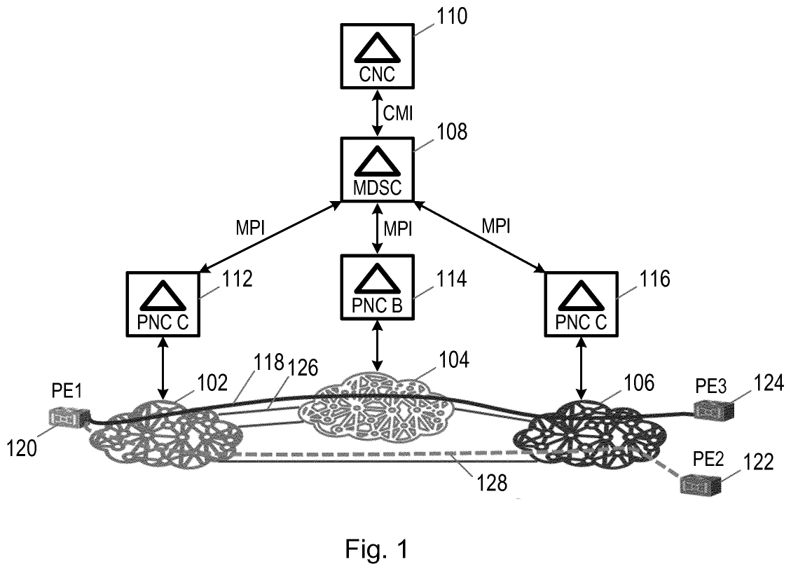

Microwave links are currently an active topic in Software Defined Networking (SDN). SDN of transport networks is increasing in popularity, with operators beginning to deploy SDN based solutions for single domain management in transport networks. Abstraction of network resources is a technique that can be applied to a single network domain or across multiple domains to create a single virtualized network that is under the control of a network operator or the customer of the operator. Abstraction and Control of Traffic Engineered Networks (ACTN) is an initiative standardised in various IETF drafts with the aim of facilitating resource abstraction in multi technology and multi-vendor transport networks. In ACTN terminology, an SDN based solution for single domain management in transport networks is referred to as a Physical Network Controller (PNC) controlled domain. The driver for the introduction of SDN in transport networks is to provide network operators with Traffic Engineering (TE) capabilities in terms of constraints to be applied to the routing of traffic in the network. Such capabilities may include for example computing paths with minimum delay, minimum cost etc. SDN promises greater automation and operational efficiency by decoupling forwarding from control/management and introducing much higher abstraction and programmability than was previously available. FIG. 1 illustrates an ACTN hierarchy for a transport network including three PNC controlled domains 102, 104, 106, a Multi Domain Service Controller (MDSC) 108 and a Customer Network Controller 110. An interface MPI is defined between the MDSC 108 and the individual PNCs 112, 114, 116, and an interface CMI is defined between the CNC 110 and the MDSC 108.

Reference 1 describes use cases for controlling microwave systems with the SDN approach, and states that “One of the main drivers for applying SDN from an operator perspective is simplification and automation of network provisioning as well as end to end network service management”. Use cases for SDN control of microwave networks include: Understand the capabilities and limitations, Initial configuration, and Radio link re-configuration and optimization.

The IETF draft “A YANG Data Model for Microwave Radio Link” draft-ietf-ccamp-mw-yang-05 (Reference 2) defines a data model for “management and control of the radio link interface(s) and the relationship to packet (typically Ethernet) and/or TDM interfaces in a microwave/millimeter wave node”. YANG (Yet Another Next Generation) is a data modelling language for the definition of data sent over the NETCONF network configuration protocol. YANG models are defined in Reference 2 for the air interface and for the packet side. The IETF draft “A YANG Data Model for Microwave Topology” draft-ye-ccamp-mw-topo-yang-00 (Reference 3) proposes a YANG data model to describe the topology of a microwave network. It is an augmentation of the TE topology model and addresses use cases of improved network planning, adaptive bandwidth configuration and capturing microwave-link specific information like the availability to drive path computation. It will be appreciated that the above noted YANG models, developed by the Internet Engineering Task Force (IETF), are referenced and discussed below for the purposes of illustration. The methods and apparatus of the present disclosure are equally applicable to YANG models developed by other organisations, including for example those developed by the Open Networking Foundation (ONF), as set out in: https://github.com/OpenNetworkingFoundation/CENTENNIAL/blob/master/models/yanq/microwave-model.yang.

In a transport network including a microwave domain and controlled according to the ACTN hierarchy of FIG. 1, the YANG data models for management and topology described in References 2 and 3 are exposed at the MPI interface between the MDSC and the PNC controlling the microwave domain (PNC 114 controlling domain 104 in FIG. 1). Line 118 represents a network slice (Virtual Network) comprising two multi-domain tunnels 126, 128. The upper tunnel 126 in FIG. 1 connects Provider Edge node 120 (PE1) to Provider Edge node 122 (PE3) across all three domains illustrated in the Figure. The lower tunnel 128 in FIG. 1 connects PE1 120 to PE2 122 across domains 102 and 106. The multi-domain tunnels 126, 128 are traffic-engineered and are associated to a service level agreement in terms of bandwidth, resiliency (which is mapped for example in a protection type at the physical layer) and so on.

It is anticipated that as a part of the continuing development of microwave networks, the following capabilities will become increasingly available in microwave nodes within PNC controlled microwave domains in the near future:

1) Configurable capacity: this can be achieved by means of configurable modulation formats and symbol rate, by using multiple carriers, multiple antennas etc. How the actual capacity is modulated to achieve the desired maximum capacity is left to the nodes (as is the case for most current deployments) and is outside the scope of this disclosure. For example, a microwave link could be configured for 1024 QAM maximum capacity but due to heavy rain only 256 QAM ensures the desired quality of transmission for short time intervals.

2) Reconfigurable microwave path: the microwave path over which a microwave node sends or receives a signal can be redirected on the horizontal plane to point to a new location described in terms of azimuth (angle on the Earth surface with respect to the North) and can be redirected on the vertical plane by changing its elevation angle (angle between the Earth surface and the microwave path). Microwave paths may also be described in terms of the latitude, longitude and elevation of an end point. The reconfiguration of a microwave path may be achieved in a relatively coarse manner using high precision DC motors and/or with a finer control using beamforming.

3) Operations and Maintenance (O&M) out-of-band channel which is always available for communicating with microwave nodes in all operating conditions and during reconfiguration of capacity and direction. The O&M channel may be realised for example via low-bandwidth commercial radio, fixed access or satellite network.

Some of the above capabilities are already available in certain microwave network deployments. Others are anticipated to become available as part of the ongoing evolution of microwave networks.

Aspects of the present disclosure provide a method for managing a microwave network that exploits some of the anticipated future capabilities of microwave nodes to provide redundancy, adaptability and energy savings in the microwave network.

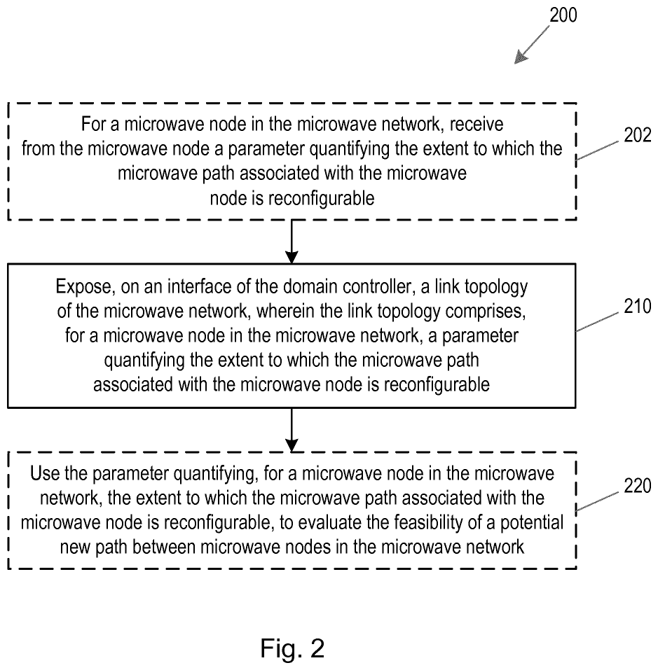

FIG. 2 is a flow chart illustrating process steps in a method 200 for managing a microwave network comprising a plurality of microwave nodes, wherein a microwave node is associated with a physical microwave path over which the microwave node is operable to transmit or receive a microwave signal, and wherein a microwave path of at least some of the microwave nodes in the microwave network is reconfigurable. The method is performed at a domain controller of the microwave network, which may for example be an SDN controller such as a Provisioning Network Controller in an ACTN hierarchy. With reference to FIG. 2, the method comprises, in step 210, exposing, on an interface of the domain controller, a link topology of the microwave network, wherein the link topology comprises, for a microwave node in the microwave network, a parameter quantifying the extent to which the microwave path associated with the microwave node is reconfigurable. As used herein, a parameter or topology may be exposed on an interface by making that parameter or topology available to another device, node or software system over the interface. For example, the other device node or software system may be enabled to perform operations on the parameter or topology (e.g., create, read, delete, etc), to perform operations using the parameter or topology, and/or to invoke methods utilizing the parameter or topology.

As noted above, for the purposes of the present specification, a microwave path of a microwave node is reconfigurable if its geographical orientation may be adjusted by the microwave node during the operational life of the node, that is after the initial deployment phase during which the path of the node may be established according to a desired topology of the microwave network. A geographical orientation of a microwave path refers to the direction in which the path travels, represented for example by azimuth and elevation angles at an end point of the path, or by coordinates of the path's end points. Reconfiguration of a microwave path is thus distinguished from reconfiguration of a signal transmitted or received over the path, including for example a change in the bit-rate, the modulation format or the digital framing of a signal transmitted or received over the path. A path may be reconfigurable owing to actuators installed at an antenna of the node and operable to change the orientation of the antenna, and/or owing to beamforming techniques applied at the node.

Also as noted above, a microwave node may be associated with a single path, which may be serviced by a single antenna or by a group of antennas operated together, for example operable to provide Multiple In Multiple Out (MIMO) functionality. Multiple nodes may therefore be co-located at the same geographical site, with different nodes associated with microwave paths connecting the site to a range of other sites in different locations, each path serviced by one or more antennas.

Referring again to FIG. 2, the method 200 may further comprise step 202, in which, for a microwave node in the microwave network, the domain controller receives from the microwave node the parameter quantifying the extent to which the microwave path associated with the microwave node is reconfigurable. The method 200 may also further comprise step 220, in which the domain controller uses the parameter quantifying, for a microwave node in the microwave network, the extent to which the microwave path associated with the microwave node is reconfigurable, to evaluate the feasibility of a potential new path between microwave nodes in the microwave network.

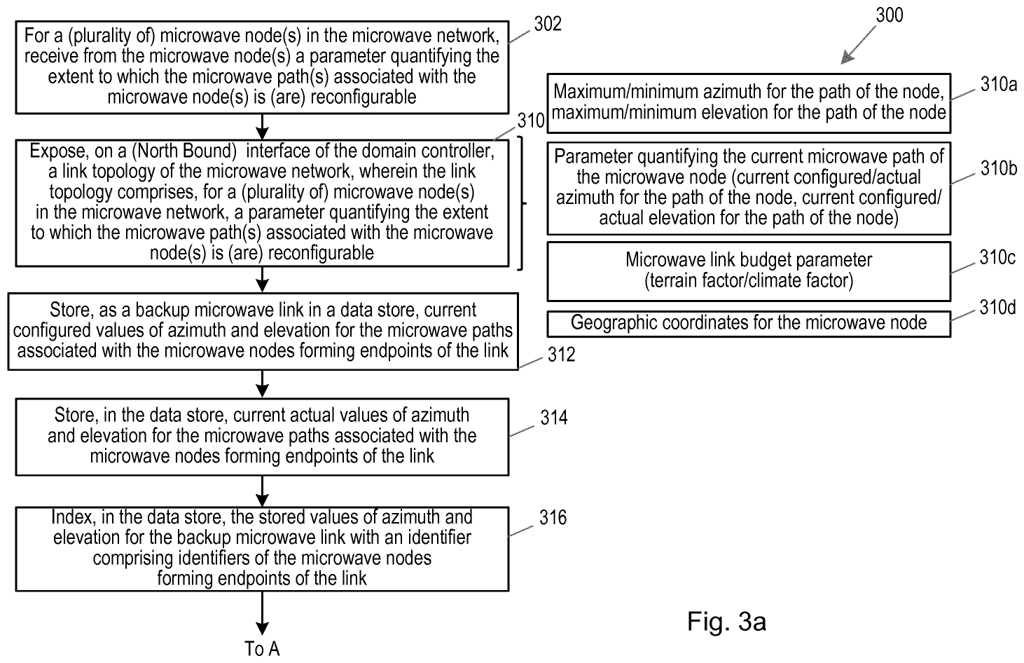

FIGS. 3a to 3c show a flow chart illustrating process steps in another example of a method a method 300 for managing a microwave network comprising a plurality of microwave nodes, wherein a microwave node is associated with a physical microwave path over which the microwave node is operable to transmit or receive a microwave signal, and wherein a microwave path of at least some of the microwave nodes in the microwave network is reconfigurable. The steps of the method 300 illustrate one way in which the steps of the method 200 may be implemented and supplemented in order to achieve the above discussed and additional functionality. As for the method 200 of FIG. 2, the method is performed at a domain controller of the microwave network, which may for example be an SDN controller such as a Provisioning Network Controller in an ACTN hierarchy.

With reference to FIG. 3a, in a first step 302, the domain controller conducting the method 300 receives, from one or more microwave nodes a parameter for each of the microwave node or nodes quantifying the extent to which the microwave path associated with the microwave node is reconfigurable.

In step 310, the domain controller exposes, on an interface of the domain controller, a link topology of the microwave network, wherein the link topology comprises, for one or more microwave node(s) in the microwave network, the parameter quantifying the extent to which the microwave path associated with the microwave node(s) is reconfigurable. Thus in step 310, the domain controller may expose some or all of the parameters received in step 302. The domain controller may receive a parameter for all nodes in the microwave network, or may in some examples only receive the parameter for those nodes having a microwave path that is reconfigurable. The domain controller may expose the link topology on the northbound interface of the controller. Thus for an example controller comprising a PNC in an ACTN hierarchy, the controller may expose the link topography on the MPI interface. As will be understood by those skilled in the art, “a northbound interface” is an interface from a lower-layer device, node or entity (in the illustrated example, a PNC) to a higher-layer device, node or entity (in the illustrated example, an MDSC). The northbound interface may conceptualize the details used by the lower-layer device, node or entity.

As illustrated at 310a, the parameter quantifying the extent to which the microwave path associated with a microwave node is reconfigurable comprises at least one of a maximum azimuth for the path of the node, a minimum azimuth for the path of the node, a maximum elevation for the path of the node and/or a minimum elevation for the path of the node. Examples of these parameters are discussed in further detail below.

As illustrated at 310b, the link topography exposed in step 310 may further comprise, for a microwave node in the microwave network, a parameter quantifying the current microwave path of the microwave node, which parameter may also have been received from the microwave node in step 302. As illustrated at 310b, the parameter quantifying the current microwave path of a microwave node comprises at least one of current configured azimuth for the path of the node, current actual azimuth for the path of the node, current configured elevation for the path of the node and/or current actual elevation for the path of the node. Current configured azimuth and elevation may comprise values of azimuth and elevation that the microwave node is configured to apply and current actual azimuth and elevation may comprise values of azimuth and elevation that are currently captured by the network for the microwave node. Current actual values may be captured by the network through measurement readings and/or reporting, and a difference between current configured and current actual values may arise owing to self-optimisation at the node or to error.

As illustrated at 310c, the link topology exposed in step 310 may further comprise, for a microwave node in the microwave network, a microwave link budget parameter, which may for example comprise at least one of a terrain factor and/or a climate factor.

As illustrated at 310d, the link topology exposed in step 310 may further comprise, for a microwave node in the microwave network, geographic coordinates for the microwave node.

In step 312, the domain controller stores, for a microwave link in the link topology of the microwave network, current configured values of azimuth and elevation for the microwave paths associated with the microwave nodes forming endpoints of the link. This information is stored as a backup microwave link in a data store. The data store may be hosted at the domain controller or may be remotely hosted and accessible to the domain controller. As illustrated in step 314, the domain controller also stores in the data store, for the backup microwave link, current actual values of azimuth and elevation for the microwave paths associated with the microwave nodes forming endpoints of the link.

In step 316, the domain controller indexes, in the data store, the stored values of azimuth and elevation for the backup microwave link with an identifier comprising identifiers of the microwave nodes forming endpoints of the link.

Referring now to FIG. 3b, the domain controller also stores in the data store at least one of a date or a time at which the backup microwave link has been used in the microwave network.

The domain controller then proceeds to use the parameter quantifying, for a microwave node in the microwave network, the extent to which the microwave path associated with the microwave node is reconfigurable, to evaluate the feasibility of a potential new path between microwave nodes in the microwave network. The use may be conditional upon a change in the link topology of the microwave network taking place or being detected or identified. Steps 320 to 324 and 336 described below illustrate examples of how the domain controller may use the indicated parameter to evaluate the feasibility of a potential new path between microwave nodes in the microwave network

In step 320, the domain controller identifies a change in the link topology of the microwave network. This may comprise identifying a microwave node in the microwave network that has become at least partially unavailable, as illustrated at 320a. A microwave node may become at least partially unavailable owing to one or more of a failure affecting the microwave node or a programmed downtime for the microwave node. Programmed downtime for a microwave node may include scheduled repairs or maintenance work, or scheduled downtime during periods of low traffic load, for example scheduled overnight downtime for energy saving.

In other examples, identifying a change in the link topology of the microwave network may comprise identifying a microwave node in the microwave network that has become newly available, as illustrated at 320b. A microwave node may become newly available owing to one or more of a new microwave node installation or a node becoming available after a failure or programmed downtime.

In step 322, the domain controller identifies a path between first and second microwave nodes in the microwave network, which path is impacted by the change in topology, the path comprising at least one microwave link. As illustrated at 322a and 322b, a path between first and second microwave nodes in the microwave network, which path is impacted by the change in topology, may include for example a path comprising a microwave link that terminates at an at least partially unavailable node, or a path the capacity of which may be increased by passing via a newly available node

In step 324, the domain controller identifies a potential new path between the first and second microwave nodes, which path maintains connectivity between the first and second nodes in the changed link topology. As illustrated at 324a and 324b, a potential new path between the first and second microwave nodes, which path maintains connectivity between the first and second nodes in the changed link topology, may comprise a path comprising a single microwave link between the first and second microwave nodes, or may comprise a path comprising a microwave link that terminates at the newly available node.

In step 326, the domain controller checks the data store for backup microwave links having the first or second microwave nodes as endpoints and, in step 328 as illustrated in FIG. 3c, the domain controller determines whether the potential new path can be formed from stored backup links. In some examples, the domain controller may check not only the topology of the stored backup links but also the weather or traffic conditions at a date and/or time associated with the backup links in order to determine whether the backup links are appropriate for use in the current weather and/or traffic conditions.

If the potential new path can be formed from stored backup links (Yes at step 330), the domain controller identifies the stored backup links required to form the potential new path in step 332 and instructs the first and second microwave nodes to reconfigure their associated microwave paths to match the microwave paths of the identified back links in step 324. The domain controller then proceeds directly to step 342 as discussed below.

If the potential new path cannot be formed from stored backup links (No at step 330), the domain controller proceeds to evaluate the feasibility of the potential new path on the basis of parameters quantifying the extent to which the microwave paths associated with the first and second microwave nodes are reconfigurable. This may comprise determining whether the parameters exposed as part of the link topology in step 320 for the first and second microwave nodes indicate that the microwave paths associated with the first and second microwave nodes can be reconfigured to form the potential new path (checking maximum and minimum azimuth, elevation, etc.). The domain controller may be aware of geographical characteristics of the region where the microwave network is deployed and may take these into account to determine feasibility of the link from established rules accounting for distance, chosen carrier frequency, margins for obstructions, atmospheric variations etc.

If the potential new path between the first and second microwave nodes is evaluated as feasible (yes at step 338), the domain controller instructs the first and second microwave nodes at step 340 to reconfigure their associated microwave paths to form the potential new path. As illustrated at 340a, this comprises configuring the first and second microwave nodes with azimuth and elevation values corresponding to microwave paths that will form the potential new path.

In step 342, the domain controller determining a difference in capacity between the identified path and the potential new path, and in step 344, the domain controller engineers traffic on the potential new path to accommodate the difference in capacity. This may comprise for example prioritising certain classes of traffic, if the capacity of the new path is less than that of the identified path.

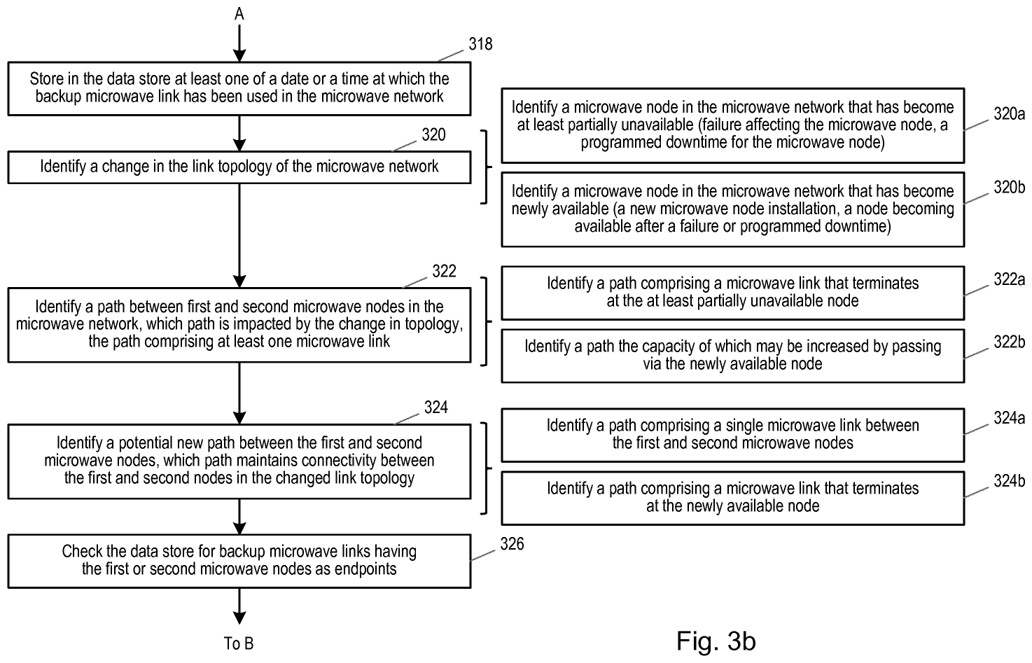

FIG. 4 is a flow chart illustrating process steps in a method 400 for operating a microwave node in a microwave network, the microwave node being associated with a physical microwave path over which the microwave node is operable to transmit or receive a microwave signal. The method 400 may compliment the method 100 and/or 200 carried out by a domain controller for the microwave network of which the microwave node is a part. Referring to FIG. 4, the method 400 comprises, in a first step 410, reporting by the microwave node, to a domain controller of the microwave network, a parameter quantifying the extent to which the microwave path associated with the microwave node is reconfigurable.

As illustrated at 410a, the parameter quantifying the extent to which the microwave path associated with the microwave node is reconfigurable comprises at least one of a maximum azimuth for the path of the node, a minimum azimuth for the path of the node, a maximum elevation for the path of the node and/or a minimum elevation for the path of the node. Examples of these parameters are discussed in further detail below.

As illustrated at 410b, the microwave node may additionally report to the domain controller a parameter quantifying the current microwave path of the microwave node, which parameter may be at least one of current configured azimuth for the path of the node, current actual azimuth for the path of the node, current configured elevation for the path of the node and/or current actual elevation for the path of the node. Current configured azimuth and elevation may comprise values of azimuth and elevation that the microwave node is configured to apply and current actual azimuth and elevation may comprise values of azimuth and elevation that are currently captured by the network for the microwave node. Current actual values may be captured by the network through measurement readings and/or reporting, and a difference between current configured and current actual values may arise owing to self-optimisation at the node or to error.

In step 412, the microwave node may receive an instruction from the domain controller to reconfigure its microwave path. This instruction may for example comprise new configured values of azimuth and elevation. The microwave node may then proceed, in step 414, to reconfigure its microwave path in accordance with the received instruction. This may for example comprise using actuators to physically change the alignment of one or more antennas at the node, and/or using beamforming techniques applied at the node to shift the microwave path associated with the node in accordance with the received instruction.

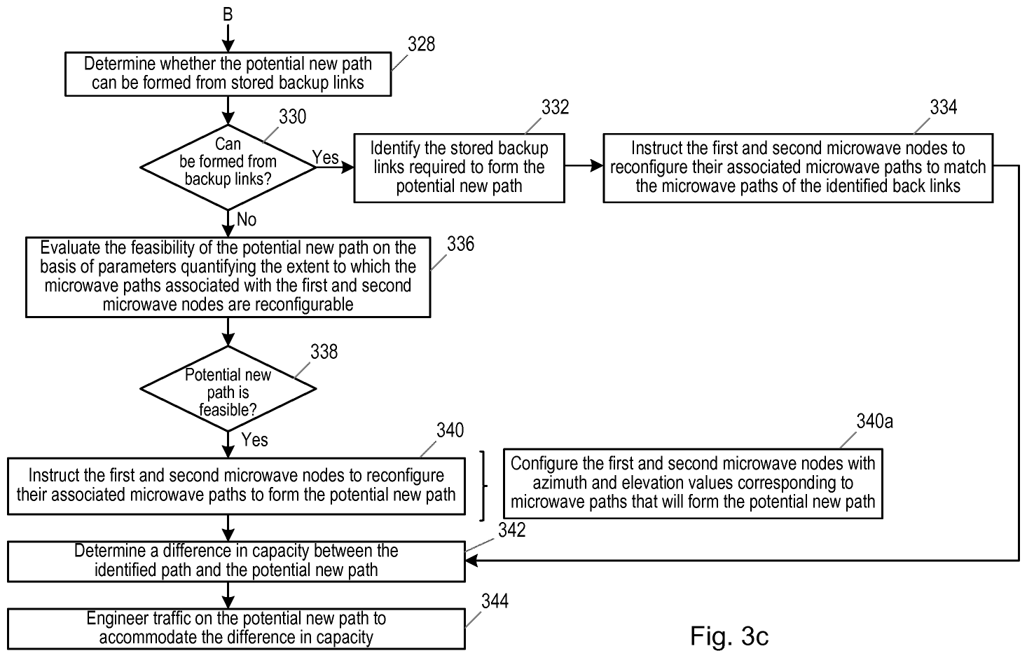

Additional details and example use cases of methods according to the present disclosure are discussed below, in the context of an example microwave network 500 illustrated in FIG. 5. Referring to FIG. 5, the example microwave network 500 comprises three node sites, Beigua, Erzelli and Fasce. Beigua and Fasce node sites each host two microwave nods: Beigua-1 and Beigua-2 and Fasce-1 and Fasce-2. Erzelli node site hosts three microwave nodes Erzelli-1, Erzelli-2 and Erzelli-3. Each microwave node is associated with a microwave path over which the microwave node transmits and receives microwave signals. The microwave nodes may comprise a single antenna, or may comprise multiple antennas, for example to provide MIMO functionality. In an initial deployment, the microwave network comprises two microwave links: link 502 between Beigua 2 and Erzelli-1 and link 504 between Erzelli-2 and Fasce-1.

As discussed above with reference to FIGS. 2 and 3, according to examples of the present disclosure, a domain controller for a microwave network exposes a link topology of the network that includes a parameter quantifying the extent to which the microwave path associated with the microwave node is reconfigurable. This parameter may be added to the YANG data model of the link topology, or to another data model used to expose network link topology to other elements in a network, such as other controllers. Examples of the parameter, and other parameters that may be included with the link topology are provided below using the example network 500:
The minimum and maximum azimuth for termination points (antennas) Example: the air interface in Erzelli-1 has a rest position with azimuth 265° and can be reconfigured by ±30°. Its minimum and maximum azimuth are therefore 235° and 295°.
The minimum and maximum elevation for termination points (antennas) Example: an air interface has a horizontal rest position (elevation 0°) and can be reconfigured from a minimum of −15° to a maximum elevation of 25°.
The configured and current azimuth and configured and current elevation Example: the antenna is configured to azimuth and elevation 110° and 4.7°. It self-optimizes azimuth and elevation by setting itself to the current values of 109.5° and 4.2°.
Parameters used in microwave link budget calculations including terrain factor (i.e. 4 for smooth terrain down to 0.25 for mountains or rough terrain) and climate factor (i.e. 1 for humid climate down to 0.25 for dry climate). These values may be used to overwrite the data obtainable from georeferenced maps used by planning systems.
The geographic coordinates of the nodes where the air interfaces are located. This information is included be in the IETF-TE-topology YANG model and may be populated. In some examples, such as if the backup links discussed below are used, then the geographic coordinates may be omitted.
Backup links including a set of named links and associated parameters which may or may not be activated. Backup links may be stored in a configuration data store and may include links which have worked successfully in the past or have been pre-configured for future use. Current configured and actual azimuth and elevation can be stored for the source and destination end points of these links.

It will be appreciated that the above parameters may be added to the link topology for both microwave nodes having fixed microwave paths in addition to reconfigurable microwave nodes, so maintain backwards compatibility. Microwave nodes having fixed microwave paths will simply indicate maximum and minimum values for azimuth, elevation etc. that are essentially same, encompassing only a small margin for self-optimization at the node.

Referring again to the example microwave network of FIG. 5, it may be envisaged that the Erzelli site encounters a problem or is required to shut down temporarily for maintenance or other purposes. In order to maintain connectivity between end nodes Beigua-2 and Fasce-1, a domain controller for the network 500 identifies a potential new path in the form of a direct link between Beigua-2 and Fasce-1. In one example, the domain controller evaluates the feasibility of this path on the basis of the parameters received for nodes Beigua-2 and Fasce-1: are the ranges for azimuth and elevation sufficient to allow the antennas at nodes Beigua-2 and Fasce-1 to be repositioned so as to form the direct link 506, taking account of geographical and other factors? If so, then instructions may be sent to nodes Beigua-2 and Fasce-1 to adjust their antennas to form the new link. In another example, the domain controller may establish that the direct link 506 between Beigua-2 and Fasce-1 and has already been activated in the past. The domain controller may therefore retrieve the stored configuration parameters for the link and instruct the nodes to recreate the link. In a still; further example, the link 506 may have been established at installation. In such an example, it may be envisaged that an installation crew was sent to Beigua-2 to setup the link Erzelli-1 to Beigua-2. In addition to setting up the intended link, the crew performed a scan of other reachable microwave sites and pre-configured a set of azimuth and elevation values for future use. Thus, the backup link 506 may be established and stored at installation to be retrieved as necessary by a domain controller during the operational life of the nodes.

It will be appreciated that the parameters discussed above may be stored manually (e.g. via a Graphical User Interface) or automatically using sensors. It will also be appreciated that the manner in which self-optimization of azimuth and elevation is performed at the microwave nodes, in addition to the manner in which self-configuration of the modulation format at the microwave nodes is performed, may be selected according to the requirements of a particular implementation or deployment.

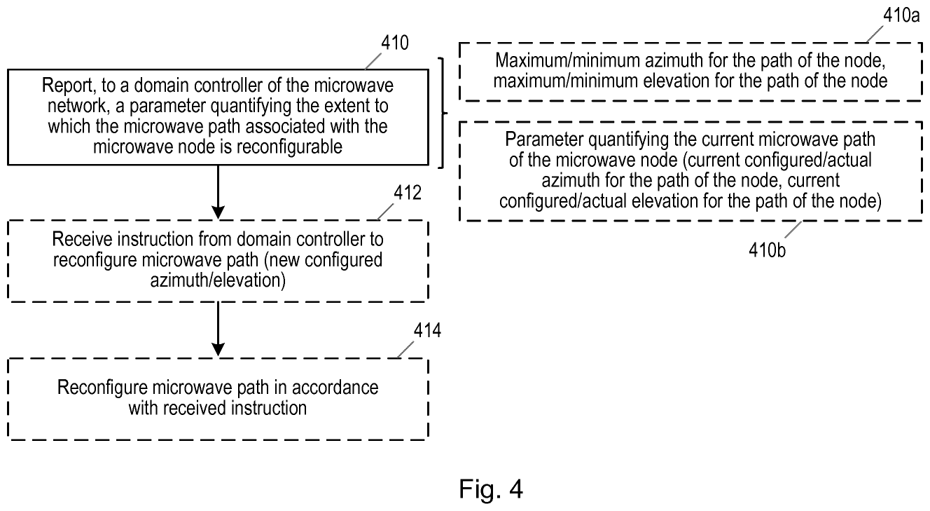

FIGS. 6 to 8 illustrate example use cases for methods according to the present disclosure implemented in an SDN controlled microwave network.

Use Case 1: Protection without Extra Hardware

Referring to FIG. 6, in a first use case, end-nodes A and C are connected via an active repeater B providing a high capacity link. If repeater B should fail or be otherwise unavailable, the SDN domain controller instructs nodes A and C to steer their antennas to face each other. As a result a longer protection path is provisioned. Longer length is traded-off with reduced capacity. The SDN domain controller can evaluate the feasibility of the new connection or exploit an appropriate backup link, if such exists. Without the possibility to reconfigure nodes A and C during their active lifetimes, a direct link between A and C would have required two extra antennas.

Use Case 2: Cost-Effective First-In Deployment

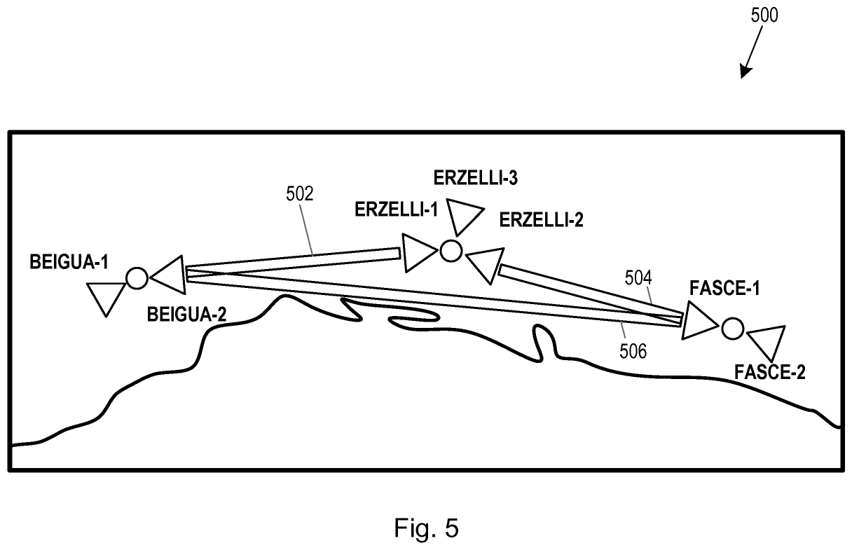

Referring to FIG. 7, in a second use case, a network is built with minimum first-in cost to connect two locations A and B. A direct link between A and B has low capacity which is sufficient to service traffic volumes at initial installation. At some later time, when traffic has increased and it is cost effective to provision a higher capacity connection between nodes A and B, a new station C is added and antennas in A and B are remotely reconfigured to face C. Shorter length paths AC and CB provide higher capacity.

Use Case 3: Energy-Efficient Networking

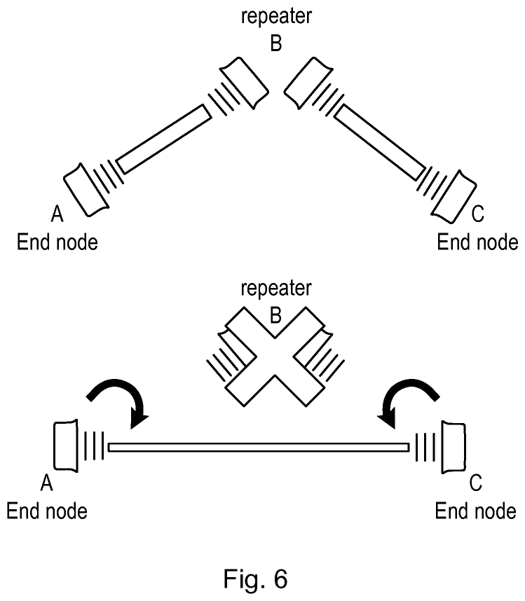

Referring to FIG. 8, in a third use case, a link between end nodes A and C has a repeater B to provide maximum capacity. When the SDN domain controller knows that the traffic between end-nodes A and C is low enough, it instructs antennas in A and C to be remotely reconfigured to face each other. The longer path between A and C offers lower capacity but is sufficient at times of low traffic, allowing the radio system of Node B to be switched off. Owing to known methods for predicting temporal traffic patterns (e.g. on a night/day basis), the opposite operation may be be performed when the traffic between A and C is expected to exceed the capacity offered by the direct link.

Use Cases 1 and 3 can be conveniently paired to an automatic system for the forecasting of traffic and/or link conditions, which may for example run in the cloud. For example, the SDN domain controller can be instructed by another application which is able to extrapolate traffic patterns or weather conditions. As a result, the controller anticipates a node reconfiguration to serve a predicted scenario.

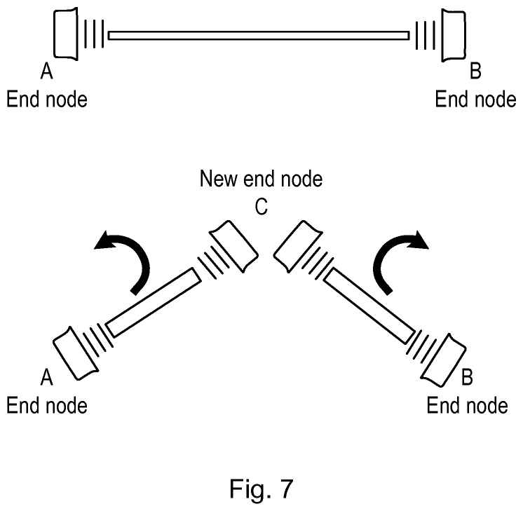

FIG. 9 is a schematic illustration of another example microwave network 900, including traffic and repeater nodes and a domain controller 902. A subset of the traffic and repeater nodes may be reconfigurable, and a parameter indicating the extent to which individual nodes are reconfigurable may be added to the link topology exposed on the north bound interface 904 of the controller 902.

### Yang Model Examples

The following examples demonstrate how the YANG model set out in Reference 3 may be amended to include a parameter according to examples of the present disclosure. Additions to the model are indicated in bold type.

```
module: ietf-microwave-topology
  augment /nw:networks/nw:network/nw:network-types/tet:te-topology:
    +--rw mw-topology!
  augment /nw:networks/nw:network/nt:link/tet:te/tet:te-link-attributes:
```

| | |
|---|---|
| +--rw mw-link-frequency? | uint32 |
| +--rw mw-link-channel-separation? | uint32 |
| +--rw mw-link-nominal-bandwidth? | rt-types:bandwidth-ieee-float32 |
| +--rw mw-link-current-bandwidth? | rt-types:bandwidth-ieee-float32 |
| +--rw mw-link-current-modulation? | identityref |

+--rw mw-link-availability* [availability]

| | |
|---|---|
| +--rw availability | rt-types:percentaqe |
| +--rw mw-link-bandwidth? | rt-types:bandwidth-ieee-float32 |

augment /nw:networks/nw:network/nw:mode/tet:te/tet:te-node-attributes:

| | |
|---|---|
| +--ro mw-node-min-azimuth? | uint16 |
| +--ro mw-node-max-azimuth? | uint16 |
| +--ro mw-node-min-elevation? | int8 |
| +--ro mw-node-max-elevation? | int8 |
| +--ro mw-node-current-azimuth? | uint16 |
| +--ro mw-node-current-elevation? | int8 |
| +--rw mw-node-configured-azimuth? | uint16 |
| +--rw mw-node-configured-elevation? | int8 |

A corresponding JSON-encoded GET of the microwave topology for the node Erzelli-1 in example network 500 would be:

```
″ietf-network:node″: [
  {
    ″node-id″: ″10.0.0.7″,
    ″ietf-te-topology:te-node-id″: ″10.0.0.7″,
    ″ietf-te-topology:te″: {
    ″oper-status″: ″up″,
    ″te-node-attributes″: {
    ″name″: ″Erzelli-1″,
    ″admin-status″: ″up″,
    ″ietf-microwave-topology:mw-node-min-azimuth″: 135,
    ″ietf-microwave-topology:mw-node-max-azimuth″: 225,
    ″ietf-microwave-topology:mw-node-current-azimuth″: 183,
    ″ietf-microwave-topology:mw-node-configured-azimuth″: 184,
    ″ietf-microwave-topology:mw-node-min-elevation″: −30,
    ″ietf-microwave-topology:mw-node-max-elevation″: 30,
    ″ietf-microwave-topology:mw-node-current-elevation″: 2,
    ″ietf-microwave-topology:mw-node-configured-elevation″: −1
  }
}
```

As discussed above, a new data store may be introduced to manage microwave backup links. Backup links may be addressed by an index and by a date/time value to capture different configurations used at different date/times of the year (e.g. corresponding to different climate conditions which may affect the optimal azimuth and/or elevation).

```
module: ietf-microwave-backup-links
  +--rw backup-links!
    +--rw backup-link* [backup-link-id backup-date]
      +--rw backup-link-id  inet:uri
      +--rw backup-date  yang: date-and-time
      +--rw near-end
```

| | |
|---|---|
| \| +--rw local-te-node-id? | te-types:te-node-id |
| \| +--rw mw-node-current-azimuth? | uint16 |
| \| +--rw mw-node-current-elevation? | int8 |
| +--rw far-end | |
| +--rw local-te-node-id? | te-types:te-node-id |
| +--rw mw-node-current-azimuth? | uint16 |
| +--rw mw-node-current-elevation? | int8 |

A JSON-encoded GET on the backup links data store for the example network 500 is illustrated below. There are two instances of the Beigua-2-Fasce-2 links and one instance of the Beigua-2-Erzelli-1 link:

```
″ietf-microwave-backup-links:backup-links″: {
  ″backup-link″: [
    {
      ″backup-link-id″:″Beigua2-Fasce1″,
      ″backup-date″:″2016-01-02T06:09:44Z″,
      ″near-end″: {
        ″local-te-node-id″: ″119.1.87.231″,
        ″mw-node-current-azimuth″: 102,
        ″mw-node-current-elevation″: −1
      },
      ″far-end″: {
        ″local-te-node-id″: ″119.1.87.131″,
        ″mw-node-current-azimuth″: 282,
        ″mw-node-current-elevation″: −1
      }
    },
    {
      ″backup-link-id″:″Beigua2-Fasce1″,
      ″backup-date″:″2018-07-01T09:03:19Z″,
      ″near-end″: {
        ″local-te-node-id″: ″119.1.87.231″,
        ″mw-node-current-azimuth″: 99,
        ″mw-node-current-elevation″: −2
      },
      ″far-end″: {
        ″local-te-node-id″: ″119.1.87.131″,
        ″mw-node-current-azimuth″: 283,
        ″mw-node-current-elevation″: 0
      }
    },
    {
      ″backup-link-id″:″Beigua2-Erzelli1″,
      ″backup-date″:″2019-05-30T06:06:09Z″,
      ″near-end″: {
        ″local-te-node-id″: ″119.1.87.231″,
        ″mw-node-current-azimuth″: 81,
        ″mw-node-current-elevation″: −2
      },
      ″far-end″: {
        ″local-te-node-id″: ″119.1.87.131″,
        ″mw-node-current-azimuth″: 259,
        ″mw-node-current-elevation″: 2
      }
    }
  ]
```

It will be appreciated that the above YANG model examples are provided for the purposes of illustration, and methods according to the present disclosure may be implemented using YANG models developed by organisations other than the IETF, or using other data modelling languages.

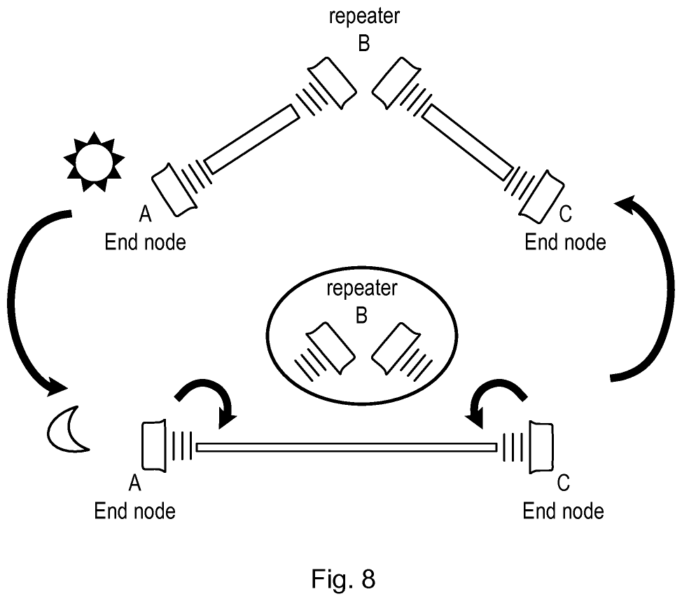

As discussed above, the methods 200, 300 may be performed by a domain controller, which may be an SDN domain controller such as a PNC. The domain controller may be a physical node or may be a Virtualised Network Function, which may for example be run in a cloud environment exploiting associated benefits of computing capability, high availability, and scalability. FIG. 10 is a block diagram illustrating an example controller 1000 which may implement the methods 200, 300 according to examples of the present disclosure, for example on receipt of suitable instructions from a computer program 1050. Referring to FIG. 10, the controller 1000 comprises a processor or processing circuitry 1002, a memory 1004 and interfaces 1006. The memory 1004 contains instructions executable by the processor 1002 such that the controller 1000 is operable to conduct some or all of the steps of the method, 200 and/or 300. The instructions may also include instructions for executing one or more telecommunications and/or data communications protocols. The instructions may be stored in the form of the computer program 1050. In some examples, the processor or processing circuitry 1002 may include one or more microprocessors or microcontrollers, as well as other digital hardware, which may include digital signal processors (DSPs), special-purpose digital logic, etc. The processor or processing circuitry 1002 may be implemented by any type of integrated circuit, such as an Application Specific Integrated Circuit (ASIC), Field Programmable Gate Array (FPGA) etc. The memory 1004 may include one or several types of memory suitable for the processor, such as read-only memory (ROM), random-access memory, cache memory, flash memory devices, optical storage devices, solid state disk, hard disk drive etc.

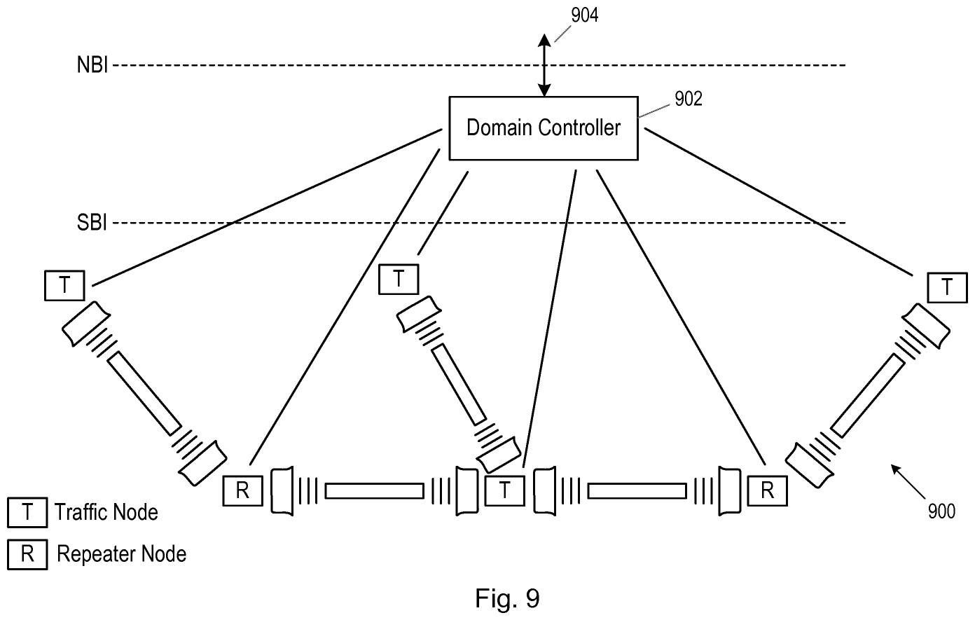

FIG. 11 illustrates functional modules in another example of controller 1100 which may execute examples of the methods 200, 300 of the present disclosure, for example according to computer readable instructions received from a computer program. It will be understood that the modules illustrated in FIG. 11 are functional modules, and may be realised in any appropriate combination of hardware and/or software. The modules may comprise one or more processors and may be integrated to any degree.

Referring to FIG. 11, the controller 1100 comprises a topology module 1110 and interfaces 1130. The controller 1100 may also comprise a receiving module 1120. The topology module 1110 may be for exposing, on an interface of the domain controller, a link topology of the microwave network, wherein the link topology comprises, for a microwave node in the microwave network, a parameter quantifying the extent to which the microwave path associated with the microwave node is reconfigurable. The term module may have conventional meaning in the field of electronics, electrical devices and/or electronic devices and may include, for example, electrical and/or electronic circuitry, devices, processors, processing circuitry, memories, logic, solid state and/or discrete devices, computer programs or instructions for carrying out respective tasks, procedures, computations, outputs, and/or displaying functions, and so on, as such as those that are described in the present disclosure.

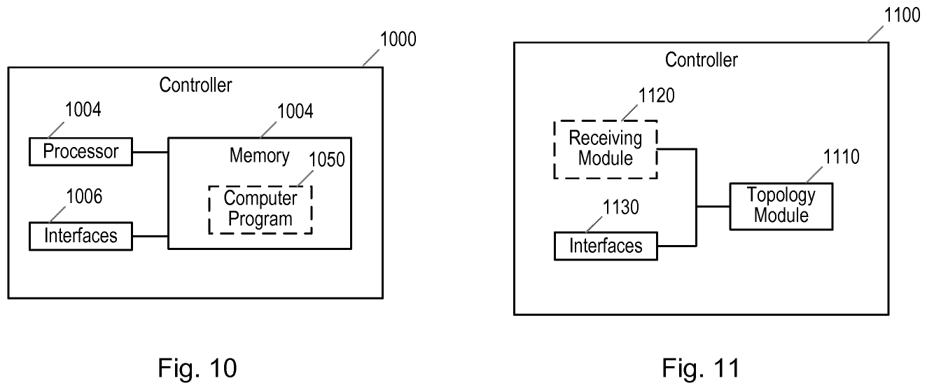

The method 400 may be performed by a microwave node, a microwave path of which may or may not be reconfigurable. FIG. 12 is a block diagram illustrating an example microwave node 1200 which may implement the method 400 according to examples of the present disclosure, for example on receipt of suitable instructions from a computer program 1250. Referring to FIG. 12, the microwave node 1200 comprises a processor or processing circuitry 1202, a memory 1204 and interfaces 1206. The memory 1204 contains instructions executable by the processor 1202 such that the microwave node 1200 is operable to conduct some or all of the steps of the method, 400. The instructions may also include instructions for executing one or more telecommunications and/or data communications protocols. The instructions may be stored in the form of the computer program 1250. In some examples, the processor or processing circuitry 1202 may include one or more microprocessors or microcontrollers, as well as other digital hardware, which may include digital signal processors (DSPs), special-purpose digital logic, etc. The processor or processing circuitry 1202 may be implemented by any type of integrated circuit, such as an Application Specific Integrated Circuit (ASIC), Field Programmable Gate Array (FPGA) etc. The memory 1204 may include one or several types of memory suitable for the processor, such as read-only memory (ROM), random-access memory, cache memory, flash memory devices, optical storage devices, solid state disk, hard disk drive etc.

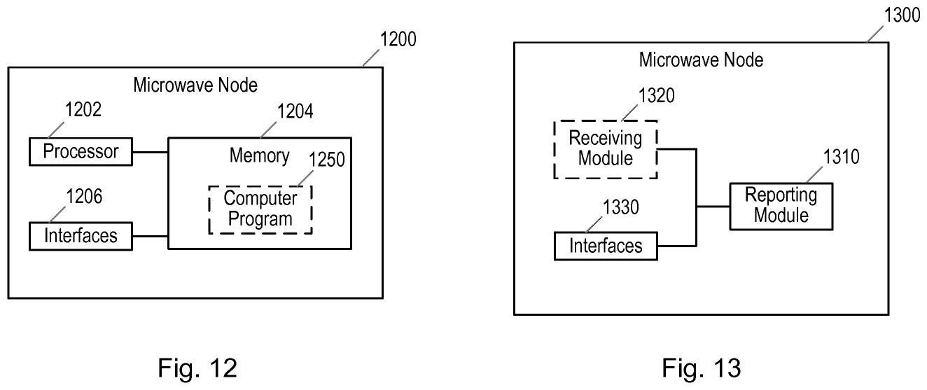

FIG. 13 illustrates functional modules in another example of microwave node 1300 which may execute examples of the method 400 of the present disclosure, for example according to computer readable instructions received from a computer program. It will be understood that the modules illustrated in FIG. 13 are functional modules, and may be realised in any appropriate combination of hardware and/or software. The modules may comprise one or more processors and may be integrated to any degree.

Referring to FIG. 13, the microwave node 1300 comprises a reporting module 1310 and interfaces 1130. The microwave node 1300 may also comprise a receiving module 1320. The reporting module 1310 may be for reporting, to a domain controller of the microwave network, a parameter quantifying the extent to which the microwave path associated with the microwave node 1300 is reconfigurable. The term module may have conventional meaning in the field of electronics, electrical devices and/or electronic devices and may include, for example, electrical and/or electronic circuitry, devices, processors, processing circuitry, memories, logic, solid state and/or discrete devices, computer programs or instructions for carrying out respective tasks, procedures, computations, outputs, and/or displaying functions, and so on, as such as those that are described in the present disclosure.

Aspects of the present disclosure thus provide methods for managing a microwave network, according to which a domain controller may expose on an interface a link topology of the microwave network which includes, for a microwave node in the microwave network, a parameter quantifying the extent to which the microwave path associated with the microwave node is reconfigurable. The interface may be a north bound interface such as the MPI (MDSC to PNC Interface) in the IETF ACTN, but may also or alternatively comprise other interfaces including NETCONF/RESTCONF interfaces defined by other standardization bodies. In some examples of the present disclosure, “backup” microwave topologies in the form of backup links may be stored at installation time or created during system life and subsequently applied when needed, so reducing the time, computation and checking required to implement an alternative path on the fly. Examples of the methods disclosed herein may enable the exploitation of reconfigurable microwave links, offering both cost and energy savings.

Examples of the present disclosure may be implemented as a NETCONF/RESTCONF Protocol/YANG model extension for a network controller controlling microwave nodes where air interfaces can be software reconfigured to realize new microwave paths and/or implement backup links. The extension may include the communication of the steering capabilities of microwave nodes in terms of azimuth and elevation and the configured and operational values of azimuth and elevation.

The methods of the present disclosure may be implemented in hardware, or as software modules running on one or more processors. The methods may also be carried out according to the instructions of a computer program, and the present disclosure also provides a computer readable medium having stored thereon a program for carrying out any of the methods described herein. A computer program embodying the disclosure may be stored on a computer readable medium, or it could, for example, be in the form of a signal such as a downloadable data signal provided from an Internet website, or it could be in any other form.

It should be noted that the above-mentioned examples illustrate rather than limit the disclosure, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1.-42. (canceled)

43. A method for managing a microwave network comprising a plurality of microwave nodes, wherein a microwave node is associated with a physical microwave path over which the microwave node is operable to transmit or receive a microwave signal, and wherein a microwave path of at least some of the microwave nodes in the microwave network is reconfigurable, the method, performed at a domain controller of the microwave network, comprising:
exposing, on an interface of the domain controller, a link topology of the microwave network, wherein the link topology comprises, for a microwave node in the microwave network, a parameter quantifying the extent to which the microwave path associated with the microwave node is reconfigurable such that the geographical orientation of the microwave path can be adjusted by the microwave node during the operational life of the node.

44. A method as claimed in claim 43, wherein the interface comprises a northbound interface.

45. A method as claimed in claim 43, wherein the parameter quantifying the extent to which the microwave path associated with a microwave node is reconfigurable comprises at least one of:
a maximum azimuth for the path of the node;
a minimum azimuth for the path of the node;
a maximum elevation for the path of the node;
a minimum elevation for the path of the node.

46. A method as claimed in claim 43, wherein the link topology of the microwave network further comprises, for a microwave node in the microwave network, a parameter quantifying the current microwave path of the microwave node.

47. A method as claimed in claim 46, wherein the parameter quantifying the current microwave path of a microwave node comprises at least one of:
current configured azimuth for the path of the node;
current actual azimuth for the path of the node;
current configured elevation for the path of the node;
current actual elevation for the path of the node.

48. A method as claimed in claim 47, wherein:
current configured azimuth and elevation comprise values of azimuth and elevation that the microwave node is configured to apply; and
current actual azimuth and elevation comprise values of azimuth and elevation that are currently captured by the network for the microwave node.

49. A method as claimed in any claim 43, wherein the link topology of the microwave network further comprises, for a microwave node in the microwave network, geographic coordinates for the microwave node.

50. A method as claimed in any claim 43, further comprising, for a microwave node in the microwave network, receiving from the microwave node the parameter quantifying the extent to which the microwave path associated with the microwave node is reconfigurable.

51. A method as claimed in claim 43, further comprising:
using the parameter quantifying, for a microwave node in the microwave network, the extent to which the microwave path associated with the microwave node is reconfigurable, to evaluate the feasibility of a potential new path between microwave nodes in the microwave network.

52. A method as claimed in claim 51, further comprising using the parameter to evaluate the feasibility of a potential new path between microwave nodes in the microwave network in the event of a change in the link topology of the microwave network.

53. A method as claimed in claim 51, wherein using the parameter quantifying, for a microwave node in the microwave network, the extent to which the microwave path associated with the microwave node is reconfigurable, to evaluate the feasibility of a potential new path between microwave nodes in the microwave network comprises:
identifying a change in the link topology of the microwave network;
identifying a path between first and second microwave nodes in the microwave network, which path is impacted by the change in topology, the path comprising at least one microwave link;
identifying a potential new path between the first and second microwave nodes, which path maintains connectivity between the first and second nodes in the changed link topology; and
evaluating the feasibility of the potential new path on the basis of parameters quantifying the extent to which the microwave paths associated with the first and second microwave nodes are reconfigurable.

54. A method as claimed in claim 53, further comprising:
if the potential new path between the first and second microwave nodes is evaluated as feasible, instructing the first and second microwave nodes to reconfigure their associated microwave paths to form the potential new path.

55. A method as claimed in claim 54, wherein instructing the first and second microwave nodes to reconfigure their associated microwave paths to form the potential new path comprises configuring the first and second microwave nodes with azimuth and elevation values corresponding to microwave paths that will form the potential new path.

56. A method for operating a microwave node in a microwave network, the microwave node being associated with a physical microwave path over which the microwave node is operable to transmit or receive a microwave signal, the method, performed at the microwave node, comprising:
reporting, to a domain controller of the microwave network, a parameter quantifying the extent to which the microwave path associated with the microwave node is reconfigurable such that the geographical orientation of the microwave path can be adjusted by the microwave node during the operational life of the node.

57. A method as claimed in claim 56, wherein the parameter quantifying the extent to which the microwave path associated with a microwave node is reconfigurable comprises at least one of:
a maximum azimuth for the path of the node;
a minimum azimuth for the path of the node;
a maximum elevation for the path of the node;
a minimum elevation for the path of the node.

58. A method as claimed in claim 56, further compromising reporting, to the domain controller of the microwave network, a parameter quantifying the current microwave path of the microwave node.

59. A method as claimed in claim 58, wherein the parameter quantifying the current microwave path of a microwave node comprises at least one of:
current configured azimuth for the path of the node;
current actual azimuth for the path of the node;
current configured elevation for the path of the node;
current actual elevation for the path of the node.

60. A computer program product comprising non transitory computer readable media having stored thereon a computer program comprising instructions which, when executed on at least one processor, cause the at least one processor to carry out a method according to claim 43.

61. A domain controller for managing a microwave network comprising a plurality of microwave nodes, wherein a microwave node is associated with a physical microwave path over which the microwave node is operable to transmit or receive a microwave signal, and wherein a microwave path of at least some of the microwave nodes in the microwave network is reconfigurable, the domain controller comprising a processor and a memory, the memory containing instructions executable by the processor such that the domain controller is operable to:
expose, on an interface of the domain controller, a link topology of the microwave network, wherein the link topology comprises, for a microwave node in the microwave network, a parameter quantifying the extent to which the microwave path associated with the microwave node is reconfigurable such that the geographical orientation of the microwave path can be adjusted by the microwave node during the operational life of the node.

62. A microwave node in a microwave network, the microwave node being associated with a physical microwave path over which the microwave node is operable to transmit or receive a microwave signal, the microwave node comprising a processor and a memory, the memory containing instructions executable by the processor such that the microwave node is operable to:
report, to a domain controller of the microwave network, a parameter quantifying the extent to which the microwave path associated with the microwave node is reconfigurable such that the geographical orientation of the microwave path can be adjusted by the microwave node during the operational life of the node.
